(19) United States
(12) Patent Application Publication
(10) Pub. No.: US 2011/0146512 A1
(43) Pub. Date: Jun. 23, 2011

(54) PRINTING PRESS WITH SEVERAL INKING UNITS

(76) Inventors: Gunter Rogge, Lienen (DE); Frank Gunschera, Osnabrueck (DE); Dietmar Koopmann, Lienen (DE)

(21) Appl. No.: 12/736,977

(22) PCT Filed: May 27, 2009
(86) PCT No.: PCT/EP2009/003746

§ 371 Date: Dec. 13, 2010

(30) Foreign Application Priority Data
May 29, 2008 (DE) 10 2008 025 993.4

(51) Int. Cl. B41F 13/24

(52) U.S. Cl. 101/248; 101/485

(57) ABSTRACT

The invention describes a printing press (1) comprising at least one impression cylinder (2), which comprises a first and a second front side and to which at least two inking systems (6a . . . 6j) each having a print roller are assigned, it being possible to set the print rollers against the impression cylinder and drive each print roller by means of a drive. A first inking system is assigned to the first half of the impression cylinder and a second inking system is assigned to the second half.

The drive of the print roller of the first inking system disposed in the first half is arranged on the first front side of the impression cylinder, and the drive of the print roller of the second inking system disposed in the second half is arranged on the first front side of the impression cylinder.

The invention relates to a printing press as defined in the generic clause of Claim 1 and a method as defined in the generic clause of Claim 5.

Printing presses, in which a plurality of inking systems is disposed around at least one common impression cylinder, are well-known. These printing presses are primarily used for the printing of flexible materials such as those used for package printing. In these printing presses, these materials are located on the impression cylinder so that they are not subjected to any deformation during the printing process.

Each of the inking systems comprises at least one print roller and at least one ink transfer roller. In flexography, often used in package printing, this ink transfer roller is an anilox roller that removes printing ink from an ink fountain, for example, from an ink chamber blade and applies it to the printing plate attached to the print roller. The ink is transferred from the printing plates onto the printing substrate. Printing presses in recent years have evolved to such effect that an independent drive is assigned to each individual print roller and anilox roller of such an inking system.

A printing press of the type described above is disclosed in DE 10 2005 039 782 A1. DE 197 55 316 A1 discloses a similar printing press, in which an independent drive is assigned to each roller, the individual drives including that of the impression cylinder being disposed in an alternating and staggered form in the axial direction.

Printing presses are known, in which eight or ten inking systems are disposed around an impression cylinder. The impression cylinder is usually mounted for rotation in a central machine frame. The impression cylinder naturally comprises first and second front surfaces, both of which extend in the vertical direction and are parallel to each other. The drive for the impression cylinder is often disposed in the region of any one of the two front sides, which is why this side is referred to as the drive side. The control console for the operating personnel is often provided in the region of the other front side. This side is therefore referred to as the operating side.

When the printing press is viewed at in the direction of one of the front sides of the impression cylinder, the printing press or the actual printing unit can theoretically be divided into two halves. For this purpose, a vertical plane can be assumed that is disposed such that the axis of rotation of the impression cylinder is located in this plane. At least one first inking system is located on one side of this plane, that is, in one half, and at least one second inking system is located in the second half.

In known printing presses, every two inking systems are often disposed and/or constructed symmetrically to the vertical plane. It is therefore necessary to provide different components for each of these two inking systems, which components do not differ in terms of their functionality but are formed so as to be mirror-inverted relative to each other. If every two adjacent inking systems are constructed variably in any one of the two halves, there would consequently be hardly any identical components inside the printing press. For such a printing press, there thus exists a very large number of components, which makes the stocking and the management of these components a laborious and thus expensive process. On the whole, this leads partly to high costs for the production of such a printing press.

DE 198 33 467 A1 therefore discloses an offset printing press, in which two printing units are positioned such that they are rotated through 180° relative to a vertical plane. In doing so, the drive means assigned to the cylinders are also disposed such that they are rotated. However, the aforementioned document does not provide any suggestions for the manner in which the anilox rollers and the drives thereof are to be arranged in order to produce the printing press more cost-effectively.

It is therefore the object of the present invention to suggest a printing press that can be produced more cost-effectively.

This object is achieved by the features of the characterizing portion of Claim 1. Accordingly, provision is made for the drive of the print roller of the first inking system disposed in the first half to be arranged on the first front side of the impression cylinder, and the drive of the print roller of the second inking system disposed in the second half to be arranged on the second front side of the impression cylinder. Provision is further made for each inking system to comprise an anilox roller, which is provided with an independent drive and can be set against the print roller, this drive being disposed at that end of the anilox roller that is located opposite to the end of the print roller at which the drive of the print roller is disposed

In printing presses of the prior art, all drives of the print rollers are arranged on one side, usually the drive side, so that this arrangement necessitated the provision of different mounting elements for the drive motor for the two halves alone. It is now suggested according to the invention to take two identical print rollers and drives and to install one print roller, for example, in the first half such that the drive is located on the drive side. The second print roller with the associated drive is not arranged in the second half so as to be mirror-inverted to the first print roller, but instead the second print roller is rotated about the vertical axis. As a result, the drive of the second print roller is now located on the operating side. Since print rollers these days are usually replaced by means of crane systems, the arrangement described above does not result in any disadvantages with regard to the operation of the printing press. But the major advantage of this arrangement is that a smaller number of different components have to be provided. This increases the number of standardized components within the printing press, which enables more effective stocking and management of components and consequently leads to a reduction of costs.

Furthermore, since each inking system comprises an anilox roller, which is provided with an independent drive and can be set against the print roller, this drive being disposed at that end of the anilox roller that is located opposite to the end of the print roller at which the drive of the print roller is disposed, the drives for the print roller and the anilox roller are located opposite to each other.

In this way, the installation space for the drives, among other things, is not limited so that the drives would have to be disposed so as to evade each other. In a view of two inking systems that are located opposite to each other relative to the vertical center plane described, the drives of the inking-system rollers are disposed in an alternating manner. All in all, the inking systems can be provided with a more compact construction which leads to a further cost reduction.

According to an advantageous development of the invention, provision is made for the functional components of at least two inking systems, a first of which is assigned to the first half and a second of which is assigned to the second half of the impression cylinder, are identical. Said functional components primarily include the inking-system brackets, the linear guides (for example, rails) that are disposed on the inking-system brackets, the bearing blocks, which can be displaced along these guides and in which the rollers or cylinders are mounted, the components disposed on these bearing blocks, the drives for the rollers and cylinders, the components for the side-lay control, all components for transmitting torque between the drive and the roller or cylinder (for example, gears), locking means for mounting the rollers or cylinders for rotation on the bearing blocks. This list is not exhaustive; it is also feasible to include additional components.

It thus becomes immediately clear that the more the number of identical components in a printing press, the more are the obvious advantages associated therewith.

In a further advantageous embodiment of the invention, at least two inking systems, a first of which is assigned to the first half and a second of which is assigned to the second half of the impression cylinder, are identical. It is particularly advantageous if all the inking systems of the printing press are identical. In this case, even a series production of inking systems can be carried out, without having to allow for the position in the printing press, at which the inking system is mounted, during production. As a result, not only are the costs for stocking the components reduced, but also the entire production process can be formed more effectively since only a small number of different components have to be supplied to the production site.

Additional exemplary embodiments of the invention are revealed in the following description and the claims.

In the individual figures:

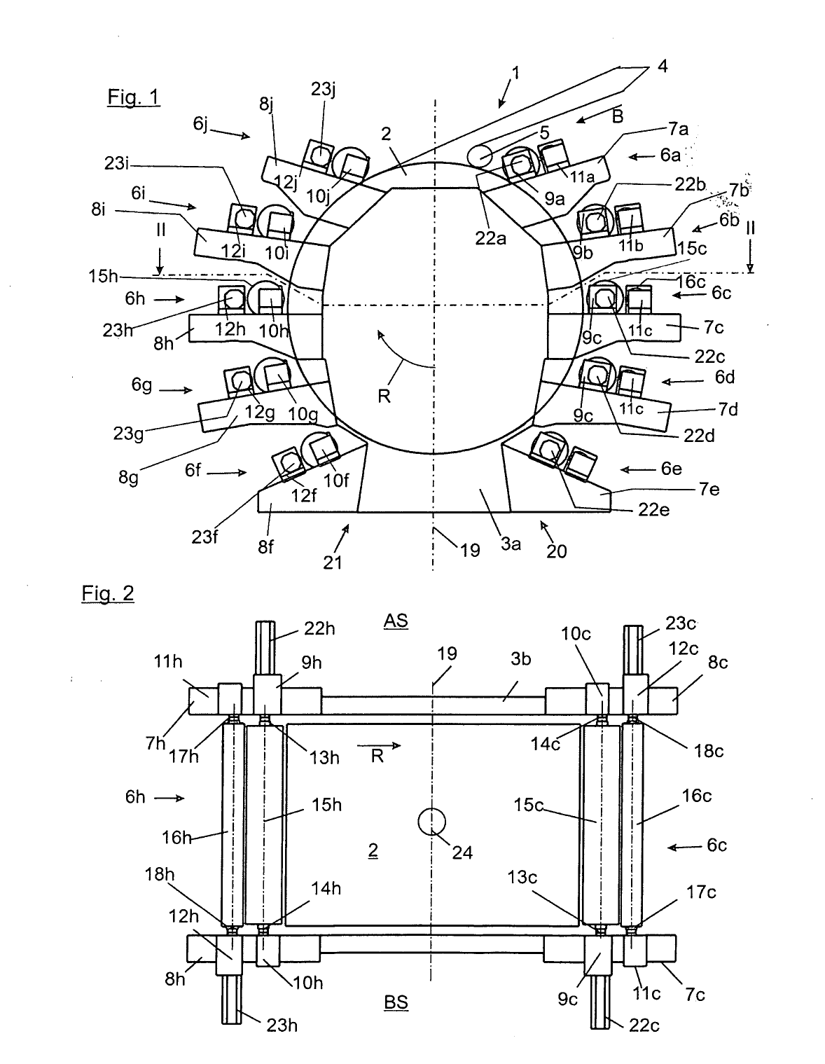

FIG. 1 is a side view of a printing unit of a central impression flexographic printing press

FIG. 2 is a view II-II marked in FIG. 1.

FIG. 1 is a side view of a printing press 1. This printing press is shown in the form of a typical central cylinder flexographic printing press. It comprises a central impression cylinder 2 that is mounted for rotation in a machine frame 3a, 3b. The web-shaped printing substrate 4 is supplied to the printing press initially in the direction of travel B of the web and is deflected by the pressure roller 5 onto the impression cylinder 2. The impression cylinder rotates in the direction of rotation R so that the printing substrate 5 can be guided past the different inking systems 6a to 6j one after the other where it is printed by means of printing inks that each correspond to the print motif.

Individual components of an inking system are now described with reference to the inking system 6c. The description is also applicable to all other inking systems 6a, 6b and 6d to 6j. The inking system 6c comprises a front bracket 7c and a rear bracket 8c (see FIG. 2). Guide elements (for example, guide rails) (not shown in the figures) are mounted on or attached to these brackets. With the help of these guide elements, the bearing blocks 9c and 10c can be displaced in the direction of the impression cylinder 2, this actuation comprising a component motion in the radial direction of the impression cylinder 2. The actuation of the two bearing blocks 9c and 10c can be carried out independently of each other. For this purpose, corresponding drives, for example, a motored spindle-spindle nut combination or a so-called linear motor, is provided on each bracket 7c and 8c. In each bearing block 9c and 10c, journals 13c and 14c of the print roller 15c are mounted for rotation by means of suitable bearings (not shown in the figures). In the bearing blocks 11c and 12c that can be moved independently of each other and preferably independently of the bearing blocks 9c and 10c, the anilox roller 16c is mounted for rotation by means of its journals 17c and 18c.

Two sides can be assigned to the printing press. The side depicted in the side view shown in FIG. 1 is often referred to as operating side BS. The opposite side is accordingly referred to as drive side AS (see FIG. 2).

The printing press 1 can be divided into different regions. A vertical center plane 19 that divides the printing press into a right half 20 and a left half 21 is shown in FIGS. 1 and 2. Half the number of the total inking systems present is disposed in each of these halves. Thus the inking systems 6a to 6e are disposed in the right half 20, and the inking systems 6f to 6j are disposed in the left half 21. In a view of the components described above, every two inking systems that are located opposite to each other relative to the vertical center plane are symmetrical in construction. In printing presses of the prior art, the inking systems are constructed mirror-symmetrically. By contrast, the inking systems in a printing press of the invention are constructed rotation-symmetrically. This will become clear from the following description.

According to the invention, this rotational symmetry is manifested in that the drive motor 22c for the print roller 15c is disposed on the operating side BS of the printing press 1, the drive motor 22h for the print roller 15h, on the other hand, is disposed on the drive side AS. The inking systems 6c and 6h comprising the print rollers 15c and 15h respectively are disposed opposite to each other relative to the vertical center plane 19.

The drive motors 23a to 23j of the anilox rollers 16a to 16j are disposed at the respective other ends. Thus for example, if the drive motor of a print roller is disposed on the operating side, the drive motor of the anilox roller assigned to this print roller is disposed on the drive side.

Accordingly, the drives of the anilox rollers of every two inking systems located opposite to each other are also disposed on opposite sides of the printing press.

The arrangement of the drives of the inking system 6h thus results from the fact that this arrangement is carried out as in the case of the inking system 6c, but is rotated through 180 degrees relative to the inking system 6c about the axis of rotation 24.

It is particularly advantageous if the essential components of an inking system are identical and are simply disposed rotation-symmetrically on the opposite side of the center plane 19. These essential components can be referred to as functional components. In a view of these functional components, two opposite inking systems are substantially or even completely identical. However, it is obvious that these functional components do not include elements such as electric cables or ink-feed tubes since these are preferably laid on one side of the printing press, for example, the drive side. For example, electric cables are usually led to control cabinets disposed centrally

Even the two parts 3a and 3b of the machine frame can be constructed rotation-symmetrically. It is also advantageous if a part of the machine frame, 3a and/or 3b, is actually divided into a right half and a left half 21, and these halves are then identical. In this case, the two identical halves of the printing press including the inking systems could first be pre-assembled and then assembled only subsequently for the construction of the printing press.

### LIST OF REFERENCE NUMERALS

1 Printing press
2 Central impression cylinder
3a, 3b Machine frame
4 Printing substrate
5 Pressure roller
6a . . . 6j Inking system
7a . . . 7j Front bracket
8a . . . 8j Rear bracket
9a . . . 9j Bearing block for the print roller
10a . . . 10j Bearing block for the print roller
11a . . . 1lj Bearing block for the anilox roller
12a . . . 12j Bearing block for the anilox roller
13a . . . 13j Journal of the print roller
14a . . . 14j Journal of the print roller
15a . . . 15j Print roller
16a . . . 16j Anilox roller
17a . . . 17j Journal of the anilox roller
18a . . . 18j Journal of the anilox roller
19 Vertical center plane
20 Right half
21 Left half
22a . . . 22j Drive motor for the print roller
23a . . . 23j Drive motor for the anilox roller
24 Axis of rotation
B Direction of travel of the web
R Direction of rotation
AS Drive side
BS Operating side

1-6. (canceled)

7. A printing press (1) comprising at least one impression cylinder (2), which comprises a first and a second front side and to which at least two inking systems (6a-6j) each having a print roller (15a-15j) are assigned, it being possible to set the print rollers (15a-15j) against the impression cylinder (2) and drive each print roller by means of a drive (22a-22j),
a first inking system being assigned to the first half of the impression cylinder and a second inking system being assigned to the second half,
an imaginary vertical center plane (19) dividing the impression cylinder (2) into a first half and a second half, and a first inking system (6c) being assigned to the first half (20) of the impression cylinder (2), and a second inking system (6h) being assigned to the second half (21), wherein
the drive (22c) of the print roller (15c) of the first inking system (6c) assigned to the first half (20) is arranged on the first front side (BS) of the impression cylinder (2), and the drive (22h) of the print roller (15h) of the second inking system (6h) assigned to the second half (21) is arranged on the second front side (AS) of the impression cylinder (2), and
each inking system (6a-6j) comprises an anilox roller (16a-16j), which is provided with an independent drive (23a-23j) and can be set against the print roller (15a-15j), this drive (23a-23j) being disposed at that end of the anilox roller (16a-16j) that is located opposite to the end of the print roller (15a-15j) at which the drive (22a-22j) of the print roller (15a-15j) is disposed.

8. The printing press (1) as defined in claim 7 wherein each inking system (6a-6j) comprises functional components such as inking-system brackets attached to a central frame of the printing press, and the functional components of at least two inking systems, a first of which is assigned to the first half and a second of which is assigned to the second half of the impression cylinder (2), are identical.

9. The printing press (1) as defined in claim 7 wherein at least two inking systems, a first of which is assigned to the first half and a second of which is assigned to the second half of the impression cylinder (2), are identical.

10. The printing press (1) as defined in claim 7 wherein all the inking systems (6a-6j) are identical.

11. A method for producing a printing press (1) comprising at least one impression cylinder, (2) which comprises a first and second front side and to which at least two inking systems (6a-6j) each having a print roller (15a-15j) are assigned, it being possible to set the print rollers (15a-15j) against the impression cylinder (2) and drive each print roller by means of a drive (22a-22j),
an imaginary vertical center plane (19) dividing the impression cylinder (2) into a first half and a second half, and a first inking system (6c) being assigned to the first half (20) of the impression cylinder (2), and a second inking system (6h) being assigned to the second half (21), wherein
the drive (22c) of the print roller (15c) of the first inking system (6c) disposed in the first half (20) is arranged on the first front side (BS) of the impression cylinder (2), and the drive (22h) of the print roller (15h) of the second inking system (6h) disposed in the second half (21) is arranged on the second front side (AS) of the impression cylinder (2), and
each inking system (6a-6j) comprises an anilox roller (16a-16j), which is provided with an independent drive (23a-23j) and can be set against the print roller (15a-15j), this drive (23a-23j) being disposed at that end of the anilox roller (16a-16j) that is located opposite to the end of the print roller (15a-15j) at which the drive (22a-22j) of the print roller (15a-15j) is disposed.
